(19) United States
(12) Patent Application Publication
(10) Pub. No.: US 2026/0140570 A1
(43) Pub. Date: May 21, 2026

(54) INFORMATION PRESENTATION METHOD, INFORMATION PRESENTATION DEVICE, INFORMATION PRESENTATION SYSTEM, AND RECORDING MEDIUM

(71) Applicant: Panasonic Intellectual Property Management Co., Ltd., Osaka (JP)

(72) Inventors: Kotaro SAKATA, Osaka (JP); Naomi TOMIYAMA, Kyoto (JP); Kenta MURAKAMI, Chiba (JP); Tetsuji FUCHIKAMI, Osaka (JP)

(21) Appl. No.: 19/444,659

(22) Filed: Jan. 9, 2026

Related U.S. Application Data
(63) Continuation of application No. PCT/JP2024/019505, filed on May 28, 2024.

(30) Foreign Application Priority Data
Jul. 24, 2023 (JP) 2023-120249

(51) Int. Cl. G06F 3/01

(52) U.S. Cl. CPC G06F 3/012; G06F 3/013

(57) ABSTRACT

An information presentation method includes: collecting, as collected information, at least one of (i) information on a posture of a subject or (ii) information on at least one of a face orientation or a direction of a line of sight of the subject; analyzing an action of the subject based on the collected information; determining, based on an analysis result of the action, a presentation image that is an image to be presented to the subject, the presentation image being an image obtained from a camera that is provided at a position different from a viewpoint of the subject and showing a range selected within a capturable range of the camera; and presenting, by a display device, the presentation image determined to the subject.

### CROSS REFERENCE TO RELATED APPLICATIONS

This is a continuation application of PCT International Application No. PCT/JP2024/019505 filed on May 28, 2024, designating the United States of America, which is based on and claims priority of Japanese Patent Application No. 2023-120249 filed on July 24, 2023. The entire disclosures of the above-identified applications, including the specifications, drawings and claims are incorporated herein by reference in their entirety.

### FIELD

The present disclosure relates to an information presentation method, an information presentation device, an information presentation system including the information presentation device, and a recording medium.

### BACKGROUND

Information has been provided to a subject by presenting one or more visual stimuli to the subject (for example, see Patent Literature (PTL) 1).

### Citation List

### Patent Literature

PTL 1: Japanese Unexamined Patent Application Publication No. 2009-69954

PTL 2: Japanese Unexamined Patent Application Publication No. 2009-87026

### Non Patent Literature

NPL 1: Yoshio Matsumoto, Jun’ichi Ido, Kentaro Takemura, and Tsukasa Ogasawara, Development of Real-time Face and Gaze Measurement System and Its Application to Intelligent Interfaces, IPSJ Transactions on Computer Vision and Image Media, vol. 47, no. SIG 15(CVIM16), pp. 10-21, October, 2006.

### SUMMARY

### Technical Problem

In providing information to a subject via one or more visual stimuli, more appropriate presentation of information has been demanded. In view of this, the present disclosure provides an information presentation method and so forth capable of providing information more suitable for a subject via one or more visual stimuli.

### Solution to Problem

An information presentation method according to one aspect of the present disclosure includes: collecting, as collected information, at least one of (i) information on a posture of a subject or (ii) information on at least one of a face orientation or a direction of a line of sight of the subject; analyzing an action of the subject based on the collected information; determining, based on an analysis result of the action, a presentation image that is an image to be presented to the subject, the presentation image being an image obtained from a camera that is provided at a position different from a viewpoint of the subject and showing a range selected within a capturable range of the camera; and presenting, by a display device, the presentation image determined to the subject.

Moreover, an information presentation device according to one aspect of the present disclosure includes: an information collector that collects, as collected information, at least one of (i) information on a posture of a subject or (ii) information on at least one of a face orientation or a direction of a line of sight of the subject; an action analyzer that analyzes an action of the subject based on the collected information; a presentation image determiner that determines, based on an analysis result of the action, a presentation image that is an image to be presented to the subject, the presentation image being obtained from a camera that is provided at a position different from a viewpoint of the subject and showing a range selected within a capturable range of the camera; and a presenter that presents the presentation image determined to the subject.

Moreover, an information presentation system according to one aspect of the present disclosure includes: the information presentation device described above; the camera; and a display device that presents the presentation image to the subject.

Moreover, one aspect of the present disclosure may also be implemented as a program for causing a computer to execute the above-described information presentation method.

Note that these general or specific aspects may be implemented using a system, a device, a method, an integrated circuit, a computer program, or a computer-readable non-transitory recording medium such as a compact disc read-only memory (CD-ROM), or may be implemented using any combination of systems, devices, methods, integrated circuits, computer programs, or recording media.

### Advantageous Effects

The present disclosure makes it possible to present information more suitable for a subject.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a use case of an information presentation system according to an embodiment.

FIG. 2 is a block diagram illustrating a functional configuration of the information presentation system according to the embodiment.

FIG. 3 is a diagram illustrating an example of a specific action according to the embodiment.

FIG. 4 is a diagram illustrating an example of a specific action according to the embodiment.

FIG. 5 is a flowchart illustrating operations of an information presentation device according to the embodiment.

### DESCRIPTION OF EMBODIMENT

### Underlying Knowledge Forming Basis of the Disclosure

A technique of presenting information to a subject via one or more visual stimuli by using a display device such as a smartphone, a television, or a projector, and virtual reality (VR) or augmented reality (AR) has been developed. In addition to the visual information in the field of view of a subject, which is a visually observable range of the subject at that time, visual assistance to the subject has been provided by supplementing information to the visual information within the field of view or providing a guidance instruction for causing the subject to move the field of view to a different field of view via the one or more visual stimuli described above (for example, see PTL 1).

As one form of such visual assistance, there is a demand to enable virtually viewing of a range that is not within the field of view (outside the field of view) of a subject. For example, when the height of stacked items significantly exceeds the height of a worker who organizes them and the worker needs to read a tag attached to a stacked item, the worker needs to bring down the stacked item, prepare a stepladder and move to a position from which the tag can be read, or view an image captured by a camera or the like relocated to the position from which the tag can be read. Such operations are complicated, and it is inefficient to perform such operations in addition to organization of stacked items, which is a primary task. When a subject desires to virtually view outside the field of view as in such an example, it is effective to present virtual information outside the field of view (an image captured by a camera) via one or more visual stimuli. However, when the subject needs to operate a camera or the like to present the information about the outside of the field of view, it is difficult to perform such an operation while performing another task. In view of this, if information outside of the field of view is automatically presented to a subject when an action indicating that the subject desires presentation of such information is detected, this enables presentation of the information about the outside of the field of view to the subject while reducing the possibility of interfering with another task. In this way, the present disclosure provides an information presentation method, etc. capable of presenting information more suitable for a subject via one or more visual stimuli.

The following is a more specific outline of the present disclosure.

An information presentation method according to a first aspect of the present disclosure includes: collecting, as collected information, at least one of (i) information on a posture of a subject or (ii) information on at least one of a face orientation or a direction of a line of sight of the subject; analyzing an action of the subject based on the collected information; determining, based on an analysis result of the action, a presentation image that is an image to be presented to the subject, the presentation image being an image obtained from a camera that is provided at a position different from a viewpoint of the subject and showing a range selected within a capturable range of the camera; and presenting, by a display device, the presentation image determined to the subject.

Such an information presentation method makes it possible to determine whether the action of the subject indicates that the subject desires presentation of a presentation image by analyzing the action of the subject, based on collected information which is at least one of (i) information on the posture of the subject or (ii) information on at least one of the face orientation or the direction of the line of sight of the subject. In addition, according to the analysis result of the action, for example, the information presentation method makes it possible to not present a presentation image when the analysis result does not indicate that the subject desires presentation of the presentation image, and to present a presentation image when the analysis result indicates that the subject desires presentation of the presentation image. As described above, whether or not to present the presentation image is automatically switched according to the action of the subject, and therefore information more suitable for the subject can be presented via one or more visual stimuli.

Moreover, an information presentation method according to a second aspect is the information presentation method according to the first aspect, in which in the collecting, an image sensor is used to collect at least one of (i) the information on the posture of the subject or (ii) the information on at least one of the face orientation or the direction of the line of sight of the subject.

This makes it possible to collect, as collected information by using an image sensor, at least one of (i) the information on the posture of the subject or (ii) the information on at least one of the face orientation or the direction of the line of sight of the subject.

Moreover, an information presentation method according to a third aspect is the information presentation method according to the first aspect, in which in the collecting, an ultrasonic sensor is used to collect at least one of (i) the information on the posture of the subject or (ii) the information on at least one of the face orientation or the direction of the line of sight of the subject.

This makes it possible to collect, as the collected information by using an ultrasonic sensor, at least one of (i) information on the posture of the subject or (ii) information on at least one of the face orientation or the direction of the line of sight of the subject.

Moreover, an information presentation method according to a fourth aspect is the information presentation method according to any one of the first to third aspects, in which in the determining, when the analysis result indicates an upward shift of a center of gravity in the posture of the subject, an image corresponding to a field of view above the field of view of the subject is determined to be the presentation image.

This makes it possible to present a presentation image corresponding to a field of view above the field of view of the subject when the analysis result indicates that an upward shift of the center of gravity in the posture of the subject.

Moreover, an information presentation method according to a fifth aspect is the information presentation method according to any one of the first to third aspects, in which in the determining, when the analysis result indicates that the posture of the subject is a posture of leaning forward, an image corresponding to a field of view in front of the field of view of the subject is determined to be the presentation image.

This makes it possible to present a presentation image corresponding to a field of view in front of the field of view of the subject when the analysis result indicates that the posture of the subject is a posture of leaning forward.

Moreover, an information presentation method according to a sixth aspect is the information presentation method according to any one of the first to fifth aspects, in which the presenting includes outputting the presentation image to smartglasses that include one or more displays positioned in front of eyes of the subject wearing the smartglasses, to present the presentation image on the one or more displays.

With this, the presentation image can be presented by using smartglasses that include one or more displays positioned in front of the eyes of the subject wearing the smartglasses.

Moreover, an information presentation method according to a seventh aspect is the information presentation method according to any one of the first to sixth aspects, in which the presenting includes outputting the presentation image to a display device that includes a display located at a position around the subject to present the presentation image on the display.

With this, the presentation image can be presented by using a display device that includes a display and located at a position around the subject.

Moreover, an information presentation method according to an eighth aspect is the information presentation method according to any one of the first to seventh aspects, in which in the collecting, the information on at least one of the face orientation or the direction of the line of sight of the subject is collected, and in the determining, the presentation image to be presented to the subject is determined based on (i) the analysis result of the action and (ii) the information on at least one of the face orientation or the direction of the line of sight of the subject.

This makes it possible to determine the presentation image to be presented to the subject, based on the analysis result of the action and information on at least one the face orientation or the direction of the line of sight of the subject.

Moreover, an information presentation method according to a ninth aspect is the information presentation method any one of the first to eighth aspects, in which the camera is configured to control at least one of a horizontal angle or a vertical angle within the capturable range, and the presenting includes outputting a control signal for controlling at least one of the horizontal angle or the vertical angle of the camera to obtain an image corresponding to the presentation image determined, and subsequently presenting the image obtained from the camera to the subject.

With this, at least one of the horizontal angle or the vertical angle of the camera is controlled to obtain the presentation image, and an image captured by the camera thus controlled can be presented as a presentation image.

Moreover, a recording medium according to a tenth aspect is a non-transitory computer-readable recording medium having recorded thereon a program for causing a computer to execute the information presentation method according to any one of the first to ninth aspects.

This makes it possible to provide the same advantageous effects as those described above for the information presentation method, by using a computer.

Moreover, an information presentation device according to an eleventh aspect includes: an information collector that collects, as collected information, at least one of (i) information on a posture of a subject or (ii) information on at least one of a face orientation or a direction of a line of sight of the subject; an action analyzer that analyzes an action of the subject based on the collected information; a presentation image determiner that determines, based on an analysis result of the action, a presentation image that is an image to be presented to the subject, the presentation image being obtained from a camera that is provided at a position different from a viewpoint of the subject and showing a range selected within a capturable range of the camera; and a presenter that presents the presentation image determined to the subject.

This makes it possible to provide the same advantageous effects as those described above for the information presentation method.

Moreover, an information presentation system according to a twelfth aspect includes: the information presentation device according to the eleventh aspect; the camera; and a display device that presents the presentation image to the subject.

This makes it possible to achieve an information presentation system that provides the same advantageous effects as those described above for the information presentation method.

Furthermore, these general or specific aspects may be implemented using a system, a device, a method, an integrated circuit, a computer program, or a non-transitory computer-readable recording medium such as a CD-ROM, or may be implemented using any combination of systems, devices, methods, integrated circuits, or recording media.

The following specifically describes one or more embodiments with reference to the drawings. Note that each of the one or more embodiments described below shows a general or specific example of the present disclosure. Therefore, the numerical values, shapes, materials, structural elements, the arrangement and connection of the structural elements, steps, processing order of the steps, etc. mentioned in the following one or more embodiments are mere examples and not intended to limit the present disclosure. Moreover, among the structural elements in the following one or more embodiments, structural elements not recited in any one of the independent claims are described as optional structural elements. Note that each diagram is a schematic diagram and is not necessarily a precise illustration. Moreover, in the figures, configurations that are essentially the same share like reference signs. Accordingly, duplicate description may be omitted or simplified.

### Embodiment

### Outline

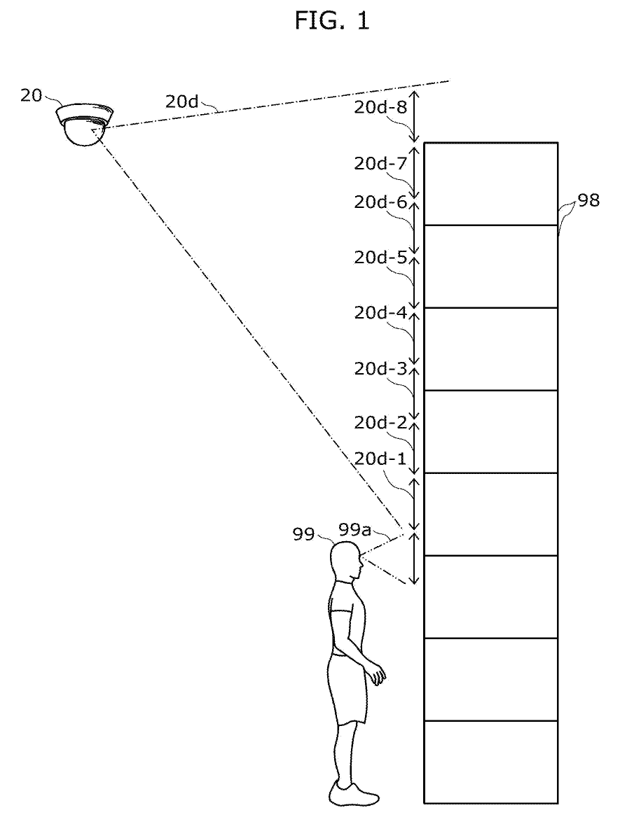

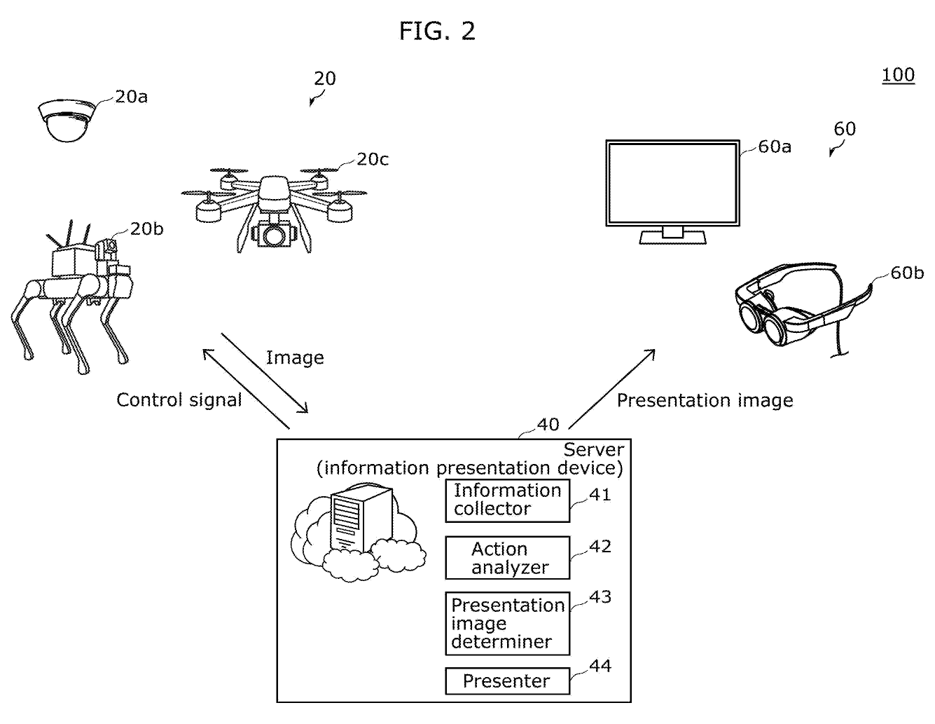

First, an outline of an information presentation system according to an embodiment will be described. FIG. 1 is a schematic diagram illustrating a use case of information presentation system 100 (see FIG. 2, which will be described later) according to the embodiment. FIG. 1 illustrates subject 99 who uses information presentation system 100, staked items 98 stacked in front of the eyes of subject 99, and camera 20. In the figure, eight stacked items 98 are stacked in the up-and-down direction (vertical direction). In field of view 99a of subject 99, although subject 99 can identify the bottom four stacked items 98 by changing the posture, it is difficult for subject 99 to identify the top four stacked items 98, which are stacked higher than (above) the height of subject 99 in the up-and-down direction. Furthermore, it is even more difficult to view especially the top surface side of stacked item 98 that is staked at the top. In view of this, when subject 99 performs a specific action (here, an action for viewing a higher position), such an action is detected by information presentation system 100. Then, among capturable ranges 20d of camera 20, an image showing an angle of view closer to the size of field of view 99a of subject 99 is selected and obtained, and output to display device 60 (see FIG. 2, which will be described later) located at a position viewable by subject 99 to present the image.

In other words, subject 99 only has to perform the specific action, and can easily input, to information presentation system 100, that subject 99 desires presentation of information outside the field of view while performing another task. Then, by performing input through such an easy action, information outside the field of view can be presented and the primary task of subject 99 can be assisted.

### Configuration

Next, a configuration of information presentation system 100 according to the present embodiment will be described with reference to FIG. 2. FIG. 2 is a block diagram illustrating a functional configuration of the information presentation system according to the embodiment.

As illustrated in FIG. 2, information presentation system 100 according to the present embodiment includes server 40 that implements an information presentation device, camera 20, and display device 60. Server 40, camera 20, and display device 60 are communicably connected to one another via a network such as the Internet.

Camera 20 is implemented by, for example, fixed camera 20a to be used with fixed to a wall surface or a ceiling surface, and camera-equipped robot 20b and camera-equipped drone 20c both controllable in position and angle via autonomous movement. All of these cameras 20 can control the horizontal angle and the vertical angle (elevation angle / depression angle) in the capturing direction by autonomous movement or adjusting pan and tilt. Stated differently, the capturable range of cameras 20 can be extended as long as the horizontal angle, vertical angle, and capturing position can be controlled. Alternatively, such a control function is not required when a fixed capturable range 20d includes an angle of view from which a necessary image can be captured. The horizontal angle and the vertical angle of camera 20 are controlled by a control signal from server 40.

There are cases where camera 20 includes a visible light image sensor that can capture a visible light image, or cases where camera 20 includes an image sensor that can capture an image of ultrashort wavelength light, such as infrared light, ultraviolet light, or x-rays. Therefore, an image of ultrashort wavelength light, such as infrared light, ultraviolet light, or x-rays, may be an image outside the field of view desired by subject 99. Stated differently, field of view 99a may also mean simply a spatial range, or a viewable wavelength range. The outside the field of view may include ultrashort wavelength light such as invisible infrared light, ultraviolet light, or x-rays. Moreover, similarly, a camera may be equipped with a telephoto function so that the camera can capture an image of a forward narrow range that cannot be viewed even within the spatial field of view. Therefore, an image of a forward narrow range that cannot be viewed even within the spatial field of view may be an image outside the field of view desired by subject 99. Stated differently, field of view 99a is a term that means a range recognizable by subject 99 in a spatial range, and if subject 99 cannot recognize a range, it is treated as outside the field of view even when the range is spatially within the field of view.

Server 40 is a device that is implemented as a cloud server or an edge server equipped with the functions of the information presentation device, and processes input information and outputs different information. Server 40 includes a processor and memory, and the functions of the information presentation device are exerted by the processor executing a predetermined program recorded on the memory. Server 40 includes information collector 41, action analyzer 42, presentation image determiner 43, and presenter 44.

Information collector 41 is a processing unit that collects information of subject 99. Information collector 41 communicates with one or more sensors (not illustrated) that can sense the position, posture, face orientation, and direction of the line of sight of subject 99, such as an image sensor, an ultrasonic sensor, a position sensor, an acceleration sensor, and an electromyography sensor. Among the position, the posture, the face orientation, and the direction of the line of sight of subject 99, information collector 41 collects, from the one or more sensors, at least one of (i) the posture or (ii) one of the face orientation or the direction of line of sight. Information collector 41 can obtain changes in information over time by obtaining (collecting) such information over time. The one or more sensors that are used by information collector 41 to collect information of subject 99 may optionally include camera 20.

Action analyzer 42 is a processing unit that analyzes an action of subject 99 based on the position, the posture, the face orientation, and the direction of line of sight of subject 99. The action of subject 99 is determined by at least one of a change in position over time, a change in posture over time, a change in face orientation over time, or a change in line of sight over time of subject 99. When at least one of the change in position over time, the change in posture over time, the change in face orientation over time, or the change in line of sight over time of subject 99 satisfies a condition, action analyzer 42 determines that subject 99 is performing a specific action. Accordingly, the specific action is defined based on whether at least one of the change in position over time, the change in posture over time, the change in face orientation over time, or the change in line of sight over time of subject 99 satisfies the condition. Optionally, the specific action may be defined based on whether at least two of the change in position over time, the change in posture over time, the change in face orientation over time, or the change in line of sight over time of subject 99 satisfy the condition. This can reduce incorrect determinations.

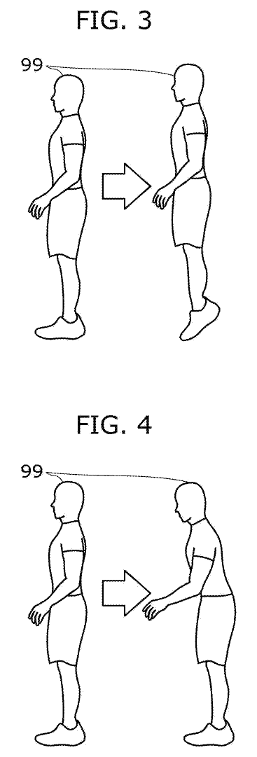

Actions of subject 99 are described in more detail. FIG. 3 is a diagram illustrating an example of a specific action according to the embodiment. FIG. 3 illustrates subject 99 is stretching upward, as an example of the specific action. Subject 99 on the left side of the arrow in the figure is not stretching upward, which means that subject 99 is not performing the specific action. In contrast, subject 99 on the right side of the arrow in the figure is stretching upward, which means that subject 99 is performing the specific action. Subject 99 is determined to be stretching upward, for example, when the skeleton model of subject 99 that is sensed as the posture of subject 99 shows (i) an upward shift of the center of gravity, especially when the speed of the shift is less than a predetermined speed, and (ii) an upward change in angle (relative angle with respect to a reference angle) of the line of sight vector of subject 99 that is sensed as a direction of the line of sight of subject 99, especially when the speed of change is less than a predetermined speed. The predetermined speeds of shifting of the center of gravity and a change in the angle of the line-of-sight vector are unique values set for each subject 99. The predetermined speeds are set to exclude actions that are not the specific actions, such as simply stretching upward or simply moving the line of sight upward.

Moreover, FIG. 4 is a diagram illustrating an example of the specific action according to the embodiment. FIG. 4 illustrates an action of subject 99 leaning forward, as an example of the specific action. Subject 99 on the left side of the arrow in the figure is not leaning forward, which means that subject 99 is not performing a specific action. In contrast, subject 99 on the right side of the arrow in the figure is leaning forward, which means that subject 99 is performing the specific action. Subject 99 is determined to be in a posture of leaning forward, for example, when the skeleton model that is sensed as a posture of subject 99 shows (i) a decrease in the angle of a joint of the lower back, especially when the change in the angle is less than a predetermined speed, and (ii) a downward change in the angle of the face orientation vector sensed as a face orientation of subject 99, especially when the speed of the change is less than a predetermined speed. The predetermined speeds are unique values set for each subject 99. The predetermined speeds are set to exclude actions that are not the specific actions, such as simply leaning forward or moving the face downward, which are not the specific actions.

Note that the face orientation and the direction of the line of sight of subject 99 are sensed by analyzing feature parts of the eyes and the face in images. For example, as such an analyzing method, PTL 2, Non Patent Literature (NPL) 1, and so on describe detailed methods. Note that this should not be construed as limiting, and the face orientation and the direction of the line of sight may be sensed by any existing sensing techniques.

Moreover, the position and posture of subject 99 are sensed by generating a skeleton model using one or more images of subject 99 and calculating spatial coordinates of each joint of subject 99. Note that, this should not be construed as limiting, and the posture of subject 99 may be estimated by converting constructions of muscles detected by one or more electromyography sensors into numerical values and calculating the numerical values, or the position and posture of subject 99 may be estimated by attaching one or more position sensors and acceleration sensors on subject 99 and sensing an attachment position of each of the one or more position sensors and acceleration sensors. Other than the above, any existing sensing techniques may be used to sense the position and posture of subject 99.

Returning to FIG. 2, presentation image determiner 43 determines an image to be presented to subject 99 from among the images showing the angle of view selected from capturable range 20d of camera 20. Presentation image determiner 43 determines a presentation image when the analysis result of the action of subject 99 indicates that subject 99 is determined to be performing a specific action such as stretching upward or leaning forward, but does not determine a presentation image when the analysis result indicates that subject 99 is not determined to be performing the specific action. In other words, a presentation image is not generated, and subject 99 will view an image of a normal field of view or directly view the normal field of view without presentation of an image.

In the determination of the presentation image, the position of subject 99 is used, but at least one of the face orientation or the direction of line of sight of subject 99 may also be used in addition to the position. Specifically, when subject 99 is stretching upward to perform a specific action, an image showing an angle of view above the position (especially the position of the viewpoint) of subject 99 is determined to be the presentation image. Alternatively, subject 99 is leaning forward to perform a specific action, an image showing a forward angle of view in front of the position (especially the position of the viewpoint) of subject 99 is determined to be the presentation image. As described above, for each specific action, the direction of shifting the angle of view for the image to be presented relative to the position of subject 99 is determined. Note that the image showing a forward angle of view may be an image that includes an enlarged forward angle of view covering a forward narrow range, or an x-ray image captured through an obstacle that blocks in front of subject 99.

The required shift of the angle of view relative to the position of subject 99 often varies with subject 99 and over time, and thus the distance of shifting the angle of view may be adjusted by subject 99. Specifically, when subject 99 performs a specific action and the shifting direction of the angle of view is determined, an image showing an angle of view that is closest to subject 99 within capturable range 20d is presented, and then the angle of view is gradually shifted in the determined shifting direction.

For example, FIG. 1 illustrates eight divided angle of views, which are angle of views 20d-1 to 20d-8, within capturable range 20d. The shifting direction is in the top-and-bottom (vertical) direction of the page. First, angle of view 20d-1 that is closest to subject 99 within capturable range 20d is presented to subject 99. Next, angle of view 20d-2 is presented, followed in sequence by angle of view 20d-3, angle of view 20d-4, angle of view 20d-5, angle of view 20d-6, and angle of view 20d-7. Finally, within capturable range 20d, angle of view 20d-8 that is farthest from subject 99 in the shifting direction is presented. When angle of view 20d-8 is presented, subject 99 can view the top surface side of stacked item 98 that is stacked at the top.

Subject 99 may adjust the shifting distance of the angle of view by inputting a stop trigger to stop the shifting of the angle of view, such as stopping the specific action, when the angle of view reaches a desired position. Note that, in the figure, although the angle of view is divided into discontinuous eight angle of views, this is merely for illustration purpose. The angle of view does not have to be divided discontinuously, and the angle of view is shifted sequentially, including overlapping regions.

Presentation image determiner 43 transmits a control signal to camera 20 to capture the determined angle of view (or determined shifting direction of the angle of view). Then, camera 20 controls the horizontal angle and the vertical angle, and when camera 20 can move autonomously, camera 20 also controls its movement so that camera 20 becomes able to capture the determined angle of view (or determined shifting direction of the angle of view).

Note that when there are a plurality of cameras 20 to constitute a stereo camera or the like, an image may be presented as a stereoscopic image aligned with the face orientation or the direction of the line of sight of subject 99. In such a case, the sensed face orientation or the sensed direction of the line of sight of subject 99 is considered in the determination of the presentation image.

Presenter 44 outputs an image showing the determined angle of view that is captured by camera 20 as a presentation image to display device 60 to cause display device 60 to display and present the image to subject 99.

Display device 60 may be display device 60a including a display and located at a position around subject 99, such as a smartphone, a tablet terminal, a smartwatch, a television, or a projector. Note that the display included in the projector is a projection surface on which an image is to be projected, and it may be understood that the term “projector” includes a projection device and a projection surface. Alternatively, display device 60 may be smartglasses 60b that include one or more displays in front of the eyes of subject 99 wearing smartglasses 60b. Display device 60 displays the presentation image output from server 40 on such a display to present the presentation image to subject 99.

### Operations

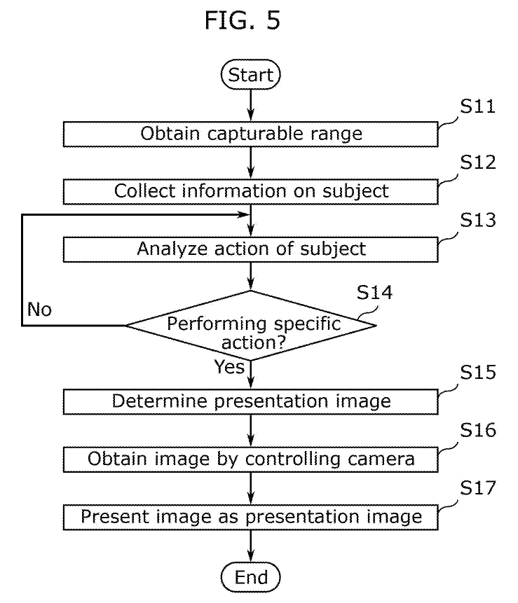

Next, with reference to FIG. 5, operations of the above-described information presentation system 100 will be described by focusing mainly on operations of server 40. FIG. 5 is a flowchart illustrating the operations of an information presentation device according to the embodiment.

As illustrated in FIG. 5, first, when the operation of information presentation system 100 is started, information presentation system 100 obtains an image capturable range of camera 20 connected to information presentation system 100 (step S11). Subsequently, information collector 41 communicates with various sensors, and collect information on subject 99 (step S12 of collecting). The collecting of information will be performed continuously thereafter. Action analyzer 42 analyzes the obtained action of subject 99 (step S13 of analyzing) and determines whether the action of subject 99 corresponds to a specific action. Action analyzer 42 outputs an analysis result indicating the determination result. Presentation image determiner 43 determines whether subject 99 is performing the specific action based on the analysis result (step S14). Then, when subject 99 is not performing any specific action (No in step S14), the process returns to step S13 of analyzing, and analyzes the action of subject 99 from newly collected information on subject 99.

When subject 99 is performing a specific action (Yes in step S14), an angle of view is determined, and an image to be obtained as a presentation image is determined (step S15 of determining). Presentation image determiner 43 transmits a control signal to camera 20 to control the horizontal angle, the vertical angle, and the capturing position of camera 20 to cause camera 20 to capture the determined angle of view.

Camera 20 changes the horizontal angle, the vertical angle, and the capturing position according to the control signal such that the determined angle of view can be captured, and starts capturing an image. Then, camera 20 transmits the captured image to server 40.

Presenter 44 receives the image transmitted from camera 20. In this way, camera 20 is controlled, and an image is obtained after camera 20 is controlled (step S16). The obtained image is output as a presentation image to smartglasses 60b of subject 99 or display device 60a located at a position around subject 99 to display the image. In this way, when subject 99 is performing a specific action, a presentation image is automatically presented (step S17 of presenting). For subject 99, since a presentation image is presented by only performing a specific action, information is presented appropriately via one or more visual stimuli while reducing the possibility of interfering with another work.

### Other Embodiments

The foregoing has described an exemplary embodiment, but the present disclosure is not limited to the above-described embodiment.

For example, the information presentation system described in the above-described embodiment may be implemented as one device including all the structural elements, or may be implemented by allocating functions to a plurality of devices and the plurality of devices coordinating with one another. In the latter case, as a device corresponding to the information presentation device, an information processing device such as a smartphone, a tablet terminal, or a personal computer (PC) may be used.

Moreover, in the above-described embodiment, processing performed by a specific processing unit may be performed by a different processing unit. Moreover, the order of a plurality of processes may be changed, or the plurality of processes may be executed in parallel.

Moreover, in the above-described embodiment, each structural element may be implemented by executing a software program suitable for the structural element. Each structural element may be implemented as a result of a program execution unit such as a central processing unit (CPU), a processor, or the like reading and executing a software program recorded on a recording medium such as a hard disk or semiconductor memory.

Moreover, each structural element may be implemented by hardware. For example, each structural element may be a circuit (or integrated circuit). These circuits may form a single circuit as a whole, or may be separate circuits. Moreover, each of these circuits may be a general-purpose circuit or a dedicated circuit.

Moreover, the general or specific aspects of the present disclosure may be implemented using a system, a device, a method, an integrated circuit, a computer program, or a computer-readable recording medium such as a CD-ROM. Moreover, the general or specific aspects of the present disclosure may be implemented using any combination of systems, devices, methods, integrated circuits, computer programs, and recording media.

For example, the present disclosure may be implemented as an information presentation method executed by a computer, or may be implemented as a program for causing a computer to execute the information presentation method. The present disclosure may be implemented as a non-transitory computer-readable recording medium having recorded thereon such a program.

Other than the above, embodiments obtained by applying various modifications, which occur to those skilled in the art, to the aforementioned one or more embodiments, and embodiments obtained by combining the structural elements and functions in the aforementioned one or more embodiments in any manner within a scope not departing from the teaching of the present disclosure are also included in the present disclosure.

### INDUSTRIAL APPLICABILITY

The present disclosure is useful to present information to a subject via one or more visual stimuli.

1. An information presentation method comprising:
collecting, as collected information, at least one of (i) information on a posture of a subject or (ii) information on at least one of a face orientation or a direction of a line of sight of the subject;
analyzing an action of the subject based on the collected information;
determining, based on an analysis result of the action, a presentation image that is an image to be presented to the subject, the presentation image being an image obtained from a camera that is provided at a position different from a viewpoint of the subject and showing a range selected within a capturable range of the camera; and
presenting, by a display device, the presentation image determined to the subject.

2. The information presentation method according to claim 1, wherein
in the collecting, an image sensor is used to collect at least one of (i) the information on the posture of the subject or (ii) the information on at least one of the face orientation or the direction of the line of sight of the subject.

3. The information presentation method according to claim 1, wherein
in the collecting, an ultrasonic sensor is used to collect at least one of (i) the information on the posture of the subject or (ii) the information on at least one of the face orientation or the direction of the line of sight of the subject.

4. The information presentation method according to claim 1, wherein
in the determining, when the analysis result indicates an upward shift of a center of gravity in the posture of the subject, an image corresponding to a field of view above the field of view of the subject is determined to be the presentation image.

5. The information presentation method according to claim 1, wherein
in the determining, when the analysis result indicates that the posture of the subject is a posture of leaning forward, an image corresponding to a field of view in front of the field of view of the subject is determined to be the presentation image.

6. The information presentation method according to claim 1, wherein
the presenting includes outputting the presentation image to smartglasses that include one or more displays positioned in front of eyes of the subject wearing the smartglasses, to present the presentation image on the one or more displays.

7. The information presentation method according to claim 1, wherein
the presenting includes outputting the presentation image to a display device that includes a display located at a position around the subject to present the presentation image on the display.

8. The information presentation method according to claim 1, wherein
in the collecting, the information on at least one of the face orientation or the direction of the line of sight of the subject is collected, and
in the determining, the presentation image to be presented to the subject is determined based on (i) the analysis result of the action and (ii) the information on at least one of the face orientation or the direction of the line of sight of the subject.

9. The information presentation method according to claim 1, wherein
the camera is configured to control at least one of a horizontal angle or a vertical angle within the capturable range, and
the presenting includes outputting a control signal for controlling at least one of the horizontal angle or the vertical angle of the camera to obtain an image corresponding to the presentation image determined, and subsequently presenting the image obtained from the camera to the subject.

10. A non-transitory computer-readable recording medium having recorded thereon a program for causing a computer to execute the information presentation method according to claim 1.

11. An information presentation device comprising:
an information collector that collects, as collected information, at least one of (i) information on a posture of a subject or (ii) information on at least one of a face orientation or a direction of a line of sight of the subject;
an action analyzer that analyzes an action of the subject based on the collected information;
a presentation image determiner that determines, based on an analysis result of the action, a presentation image that is an image to be presented to the subject, the presentation image being obtained from a camera that is provided at a position different from a viewpoint of the subject and showing a range selected within a capturable range of the camera; and
a presenter that presents the presentation image determined to the subject.

12. An information presentation system comprising:
the information presentation device according to claim 11;
the camera; and
a display device that presents the presentation image to the subject.
